(19) United States
(12) Patent Application Publication
(10) Pub. No.: US 2026/0219611 A1
(43) Pub. Date: Jul. 30, 2026

(54) FIXING DEVICE AND IMAGE FORMING APPARATUS

(71) Applicant: FUJIFILM Business Innovation Corp., Tokyo (JP)

(72) Inventors: Hitoshi KOMURO, Kanagawa (JP); Seiji TAIRA, Kanagawa (JP); Yasutaka NAITO, Kanagawa (JP); Hideaki OHARA, Kanagawa (JP); Kenji OMORI, Kanagawa (JP)

(73) Assignee: FUJIFILM Business Innovation Corp., Tokyo (JP)

(21) Appl. No.: 19/424,127

(22) Filed: Dec. 18, 2025

(30) Foreign Application Priority Data
Jan. 24, 2025 (JP) 2025-010972

(51) Int. Cl. G03G 15/20

(52) U.S. Cl. CPC G03G 15/2057; G03G 15/2064; G03G 2215/2051

(57) ABSTRACT

A fixing device includes a fixing member including a base material layer, an elastic layer disposed on the base material layer, and a surface layer that is disposed on the elastic layer and is a cured product of a composition containing a silsesquioxane compound, a heating member that is configured to heat the fixing member, and a pressurizing member disposed to be in contact with an outer peripheral surface of the fixing member, in which, in the surface layer of the fixing member, a ratio of an indentation depth B at a time of load release to an indentation depth A at a time of load application (=B/A×100%) in an ultramicrohardness test (JIS Z 2255:2003) is 45% or less.

### CROSS-REFERENCE TO RELATED APPLICATIONS

This application is based on and claims priority under 35 USC 119 from Japanese Patent Application No. 2025-010972 filed Jan. 24, 2025.

### BACKGROUND

### (i) Technical Field

The present invention relates to a fixing device and an image forming apparatus.

### (ii) Description of Related Art

For example, JP2617858B discloses “elastic body formed of an addition-type silicone rubber elastic material, in which the addition-type silicone rubber elastic material is a cured product of a polysiloxane mixture containing at least (a) a vinyl group-terminated linear dimethylpolysiloxane having a viscosity at 25° C. of 80,000 poise or less, and (b) a resinous organopolysiloxane having a viscosity at 25° C. of 10 poise or more, that contains a block copolymer having two or more vinyl groups and having, within the same molecule, a resin segment containing at least one of tetrafunctional or trifunctional siloxane units and a linear oil segment having at least 100 consecutive difunctional structural units.

### SUMMARY

Aspects of non-limiting embodiments of the present disclosure relate to a fixing device that reduces scratches on a surface layer of a fixing member and that has excellent release properties of a toner even in a case of fixing a toner image onto a recording medium having a large roughness or a large thickness, as compared with a case where “the surface layer of the fixing member is a fluororesin” or a case where “a ratio of an indentation depth B at a time of load release to an indentation depth A at a time of load application (=B/A×100%) in an ultramicrohardness test is more than 45%”.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided a fixing device including:
a fixing member including a base material layer, an elastic layer disposed on the base material layer, and a surface layer that is disposed on the elastic layer and is a cured product of a composition containing a silsesquioxane compound;
a heating member that is configured to heat the fixing member; and
a pressurizing member disposed to be in contact with an outer peripheral surface of the fixing member,
in which, in the surface layer of the fixing member, a ratio of an indentation depth B at a time of load release to an indentation depth A at a time of load application (=B/A×100%) in an ultramicrohardness test (JIS Z 2255:2003) is 45% or less.

### BRIEF DESCRIPTION OF THE DRAWINGS

Exemplary embodiment(s) of the present invention will be described in detail based on the following figures, wherein:

FIG. 1 is a view schematically showing a configuration of an example of a first exemplary embodiment of a fixing device according to the present exemplary embodiment;

FIG. 2 is a view schematically showing a configuration of an example of a second exemplary embodiment of a fixing device according to the present exemplary embodiment;

FIG. 3 is a view schematically showing a configuration of an example of a third exemplary embodiment of a fixing device according to the present exemplary embodiment; and

FIG. 4 is a view schematically showing a configuration of an example of an image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the invention.

Regarding the numerical ranges described in stages in the present specification, the upper limit value or lower limit value of a numerical range may be replaced with the upper limit value or lower limit value of another numerical range described in stages. In addition, in the present specification, the upper limit value or lower limit value of a numerical range may be replaced with values described in examples.

Each component may include a plurality of kinds of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

In a case where the exemplary embodiments are described with reference to the drawings, members having substantially the identical function are marked with the same reference numeral throughout all the drawings such that the members will not be redundantly described.

### Fixing Device

The fixing device according to the first exemplary embodiment is a fixing device including a fixing member including a base material layer, an elastic layer disposed on the base material layer, and a surface layer that is disposed on the elastic layer and is a cured product of a composition containing a silsesquioxane compound, a heating member that is configured to heat the fixing member, and a pressurizing member disposed to be in contact with an outer peripheral surface of the fixing member, in which, in the surface layer of the fixing member, a ratio of an indentation depth B at a time of load release to an indentation depth A at a time of load application (=B/A×100%) in an ultramicrohardness test (JIS Z 2255:2003) is 45% or less.

The fixing device according to the second exemplary embodiment is a fixing device including a fixing member including a base material layer, an elastic layer disposed on the base material layer, and a surface layer that is disposed on the elastic layer and is a cured product of a composition containing a silsesquioxane compound and a rubber, a heating member that is configured to heat the fixing member, and a pressurizing member disposed to be in contact with an outer peripheral surface of the fixing member.

Hereinafter, matters common to the first exemplary embodiment and the second exemplary embodiment will be referred to as the present exemplary embodiment.

Hereinafter, the “fixing device including a fixing member including a base material layer, an elastic layer disposed on the base material layer, and a surface layer disposed on the elastic layer, a heating member that is configured to heat the fixing member, and a pressurizing member disposed to be in contact with an outer peripheral surface of the fixing member” will be referred to as a specific fixing device.

In the specific fixing device adopting a thermal pressure fixing method, in the related art, a fluororesin is used for a surface layer of a fixing member in order to impart toner release properties. However, in a case where a recording medium is supplied to a nip portion formed at a contact portion between a fixing member and a pressurizing member in the surface layer containing the fluororesin in the related art, the fixing member may be scratched at an end part or a width end part of the recording medium. Occurrence of scratches during supply of the recording medium is particularly remarkable because, in a case where the toner image to be fixed has a thickness or the recording medium has roughness, it is necessary to increase a surface pressure in the nip portion from the viewpoint of fixing properties. In a case where the toner image is fixed with the scratches on the surface layer of the fixing member, this can be one of causes of defective image quality. In order to suppress the above-described occurrence of the scratches during the supply of the recording medium, in a case where the surface pressure in the nip portion is reduced from the viewpoint of fixing properties, an amount of deformation of the surface layer of the fixing member is suppressed, and the occurrence of the scratches on the fixing member is likely to be reduced, but the toner fixing properties and the toner release properties tend to be reduced by the reduction in the surface pressure in the nip portion. In addition, roughness-following property of the recording medium is likely to be reduced.

In the related art, a method of rubbing and polishing the surface layer of the fixing member on which the scratches occur with a roll or the like, on which inorganic particles are attached, to the surface to make the scratches less noticeable is proposed (for example, JP2009-229792A and the like). However, in the method, there are problems such as need to set a polishing period, attachment of abrasion powder, an unstable polishing effect, and reduction in film thickness of the surface layer of the fixing member due to polishing, that shortens the life of the fixing member.

On the other hand, since the fixing device according to the present exemplary embodiment has the above-described configuration, the scratches on the surface layer of the fixing member are reduced and the release properties of the toner are excellent even in a case of fixing a toner image onto a recording medium having a large roughness (for example, REZAKKU 66 paper) or a large thickness (for example, a solid image of 50% of four colors). The mechanism is not necessarily clear, but is presumed as follows.

In the fixing device according to the first exemplary embodiment, the surface layer of the fixing member is a cured product of a composition containing a silsesquioxane compound and a rubber, and a ratio of an indentation depth B at a time of load release to an indentation depth A at a time of load application (=B/A×100%) in an ultramicrohardness test (JIS Z 2255:2003) of the surface layer of the fixing member is 45% or less.

The silsesquioxane compound has intermediate physical properties between inorganic silica and organic silicone, due to structural characteristics thereof. Therefore, the surface layer containing the compound represented by Formula 1 has both inorganic characteristics such as heat resistance and hardness and organic characteristics such as flexibility and workability. Furthermore, the ratio of the indentation depths in the ultramicrohardness test described above is 45% or less. By the combination, appropriate hardness and elasticity are imparted to the surface layer. As a result, plastic deformation of the surface layer is suppressed even in a case of the supply of the recording medium and in a case of stress concentration on a thickness of the recording medium or a corner of a cut edge. As a result, the scratches on the surface layer of the fixing member are reduced, and thus the release properties of the toner are excellent.

In the fixing device according to the second exemplary embodiment, the surface layer of the fixing member is a cured product of a composition containing a silsesquioxane compound and a rubber. By the combination of the silsesquioxane compound and the rubber, appropriate hardness and elasticity are imparted to the surface layer. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

In addition, in the fixing device according to the present exemplary embodiment, since it is not necessary to reduce the surface pressure in the nip portion from the viewpoint of fixing properties in order to suppress the occurrence of the scratches during the supply of the recording medium described above, the roughness-following property of the recording medium is also excellent.

In addition, since the fixing device according to the present exemplary embodiment has the above-described configuration, appropriate hardness and elasticity are imparted to the surface layer of the fixing member, and thus the toner fixing properties are also excellent.

Hereinafter, each configuration of the fixing device will be described, but matters specified in each of the first exemplary embodiment and the second exemplary embodiment are common to both the first exemplary embodiment and the second exemplary embodiment, except for the matters specified in each of the first exemplary embodiment and the second exemplary embodiment.

### Surface Pressure in Nip Portion

An average value of the surface pressure in the nip portion formed at the contact portion between the fixing member and the pressurizing member is not particularly limited, but from the viewpoint of fixing properties, the average value is, for example, preferably 0.2 MPa or more and 1.0 MPa or less, more preferably 0.2 MPa or more and 0.8 MPa or less, and still more preferably 0.3 MPa or more and 0.6 MPa or less.

The average value of the above-described surface pressure in the nip portion may be 0.2 MPa or more.

The fixing device according to the present exemplary embodiment is excellent in suppressing the occurrence of the scratches during the supply of the recording medium and in the toner release properties even in a case where the surface pressure in the nip portion is 0.2 MPa or more, as compared with the fixing device including the fixing member in which the surface layer is a fluororesin layer in the related art. In addition, since the surface pressure in the nip portion can be 0.2 MPa or more, the roughness-following property of the recording medium is more excellent.

### Fixing Member

The fixing member has a laminated structure in which the base material layer, the elastic layer, and the surface layer are laminated in this order.

The fixing member is not limited to the above-described layer configuration, and for example, a layer configuration in which a known metal layer for electromagnetic induction heating, a protective layer thereof, and an adhesive layer are interposed between the base material layer and the elastic layer may be adopted as necessary. In addition, a layer configuration in which an adhesive layer is interposed between the elastic layer and the surface layer may be adopted.

The fixing member according to the present exemplary embodiment may have a roll shape or a belt shape.

### Base Material Layer

In a case where the fixing member has a roll shape, examples of the base material layer include a cylindrical body formed of a metal (aluminum, SUS, iron, copper, or the like), an alloy, ceramics, a fiber-reinforced metal (FRM), or the like.

In a case where the fixing member has a roll shape, as for an outer diameter and a thickness of the base material layer, for example, the outer diameter may be 10 mm or more and 1,000 mm or less. For example, in a case where the fixing member is made of aluminum, the thickness is 0.5 mm or more and 4 mm or less; and in a case where the fixing member is made of stainless steel (SUS) or iron, the thickness is 0.1 mm or more and 2 mm or less.

In a case where the fixing member has a belt shape, examples of the base material layer include a metal belt (for example, a metal belt of nickel, aluminum, stainless steel, or the like) and a resin belt (for example, a resin belt of polyimide, polyamideimide, polyphenylene sulfide, polyether ether ketone, polybenzimidazole, or the like).

The resin belt may contain a conductive powder or the like in order to control a volume resistivity. Specific examples of the resin belt include a polyimide belt in which carbon black is added and dispersed to control the volume resistivity. In addition, examples of the belt also include a belt formed by combining both ends of a long polyimide sheet on a puzzle and performing thermocompression using a thermocompression member to obtain a belt-shaped product.

In a case where the fixing member has a belt shape, a thickness of the base material layer is, for example, preferably 20 μm or more and 200 μm or less, more preferably 40 μm or more and 120 μm or less, and still more preferably 50 μm or more and 100 μm or less.

A metal layer may be provided in the base material layer as necessary. In a case where the metal layer is provided, the metal layer may be formed in a single layer or may be formed in multiple layers. The metal layer formed in a single layer may be a metal layer that generates heat by electromagnetic induction. In addition, the metal layer formed in multiple layers may be formed in a three-layer structure of, for example, an underlayer metal layer, an electromagnetic induction metal layer, and a metal protective layer.

In addition, an adhesive may be applied to the surface of the base material layer (including the base material provided with the metal layer). That is, the adhesive is used as necessary, and the base material layer (or the metal layer on the base material) and the elastic layer may be laminated with the adhesive interposed therebetween. The adhesive is not particularly limited, and examples thereof include an adhesive compound (adhesive) having a hydrogen-bonding silyl group (—SiH) in which a hydrogen atom is bonded.

### Elastic Layer

The elastic layer may be configured to contain a heat-resistant elastic material that restores the original shape even in a case of being deformed by applying an external force of, for example, 100 Pa.

Examples of the heat-resistant elastic material include a fluororesin, a silicone resin, silicone rubber, fluororubber, and fluorosilicone rubber. As the heat-resistant elastic material, from the viewpoint of heat resistance, thermal conductivity, insulating properties, and the like, for example, silicone rubber or fluororubber is preferable, and silicone rubber is more preferable.

Examples of the silicone rubber include RTV silicone rubber, HTV silicone rubber, and liquid silicone rubber; and specific examples thereof include polydimethyl silicone rubber (MQ), methyl vinyl silicone rubber (VMQ), methyl phenyl silicone rubber (PMQ), and fluorosilicone rubber (FVMQ).

Examples of a commercially available product of the silicone rubber include liquid silicone rubber SE6744 manufactured by Dow Corning Toray Co., Ltd.

As the silicone rubber, for example, silicone rubber that is crosslinked generally by an addition reaction is preferable. In addition, various types of functional groups are known for silicone rubber, and for example, dimethyl silicone rubber having a methyl group, methyl phenyl silicone rubber having a methyl group and a phenyl group, vinyl silicone rubber having a vinyl group (vinyl group-containing silicone rubber), or the like is preferable. For example, vinyl silicone rubber having a vinyl group is more preferable, and silicone rubber that has an organopolysiloxane structure having a vinyl group and a hydrogen organopolysiloxane structure having a hydrogen atom bonded to a silicon atom (SiH) is still more preferable.

Examples of the fluororubber include vinylidene fluoride-based rubber, tetrafluoroethylene/propylene-based rubber, tetrafluoroethylene/perfluoromethyl vinyl ether rubber, phosphazene-based rubber, and fluoropolyether rubber.

Examples of a commercially available product of the fluororubber include VITON B-202 manufactured by DuPont Dow Elastomers, L.L.C.

For example, it is preferable that the elastic layer contains, as the heat-resistant elastic material, silicone rubber as a principal component (that is, contains 50% by mass or more of the silicone rubber with respect to the elastic layer). The content of the silicone rubber is, for example, more preferably 90% by mass or more, and still more preferably 99% by mass or more.

In addition to the heat-resistant elastic material, the elastic layer may contain an inorganic filler for the purpose of reinforcement, heat resistance, heat transfer, and the like. Examples of the inorganic filler include known inorganic fillers, and preferred examples thereof include fumed silica, crystalline silica, iron oxide, alumina, and metallic silicon.

In addition to the above, examples of the material of the inorganic filler include known inorganic fillers such as carbides (for example, carbon black, carbon fibers, carbon nanotubes, and the like), titanium oxide, silicon carbide, talc, mica, kaolin, calcium carbonate, calcium silicate, magnesium oxide, graphite, silicon nitride, boron nitride, cerium oxide, and magnesium carbonate. Among these, from the viewpoint of thermal conductivity, for example, silicon nitride, silicon carbide, graphite, boron nitride, or carbides are preferable.

A content of the inorganic filler may be determined by the required thermal conductivity, mechanical strength, and the like, and is, for example, 1% by mass or more and 20% by mass or less with respect to the elastic layer, preferably 3% by mass or more and 15% by mass or less, and more preferably 5% by mass or more and 10% by mass or less.

The elastic layer may contain, as an additive, for example, a softener (such as a paraffin-based softener), a processing aid (such as stearic acid), an antioxidant (such as an amine-based antioxidant), a vulcanizing agent (such as sulfur, a metal oxide, and a peroxide), a functional filler (such as alumina), or the like.

A thickness of the elastic layer is, for example, preferably 30 μm or more and 600 μm or less, and more preferably 100 μm or more and 500 μm or less.

An average thickness of the elastic layer may be 100 μm or more, 200 μm or more, 300 μm or more, or 400 μm or more.

In a case where the average thickness of the elastic layer of the fixing member is 100 μm or more, a difference in hardness and elasticity between the elastic layer and the surface layer provided on the elastic layer is likely to be large, and thus the plastic deformation of the surface layer that occurs during the supply of the recording medium is likely to be larger. As a result, in a case of fixing a toner image onto a recording medium having a large roughness or a large thickness, the scratches on the surface layer of the fixing member are more likely to occur.

On the other hand, since the fixing device according to the present exemplary embodiment has the above-described configuration, even in a case where the average thickness of the elastic layer of the fixing member is 100 μm or more and the toner image is fixed onto a recording medium having a large roughness or a large thickness, the plastic deformation of the surface layer that occurs during the supply of the recording medium is suppressed to be small, and thus the scratches on the surface layer of the fixing member are suppressed.

A JIS-A hardness of the elastic layer is not particularly limited, but is, for example, preferably 15° or more and 65° or less, and more preferably 20° or more and 55° or less.

The JIS-A hardness of the elastic layer may be 50° or less.

In a case where the JIS-A hardness of the elastic layer of the fixing member is 50° or less, a difference in hardness between the elastic layer and the surface layer provided on the elastic layer is likely to be large, and thus the plastic deformation of the surface layer that occurs during the supply of the recording medium is likely to be larger. As a result, in a case of fixing a toner image onto a recording medium having a large roughness or a large thickness, the scratches on the surface layer of the fixing member are more likely to occur.

On the other hand, since the fixing device according to the present exemplary embodiment has the above-described configuration, even in a case where the JIS-A hardness of the elastic layer of the fixing member is 50° or less and the toner image is fixed onto a recording medium having a large roughness or a large thickness, the plastic deformation of the surface layer that occurs during the supply of the recording medium is suppressed to be small, and thus the scratches on the surface layer of the fixing member are suppressed.

The JIS-A hardness refers to a value measured using a type A durometer defined in JIS K 7215 (1986) according to a hardness test method specified in JIS K 7311 (1995).

A method of setting the JIS-A hardness of the elastic layer to be in the above-described range is not particularly limited, and examples thereof include known methods such as a method of adjusting a molecular weight of the heat-resistant elastic material in the elastic layer, a method of compounding a crosslinking agent to adjust a crosslinking degree, and a method of using a high-hardness filler to increase the hardness; and any of the methods may be used.

The elastic layer may contain other components. Examples of the other components include a filler, a conductive material, a softener (such as a paraffin-based softener), a processing aid (such as stearic acid), an antioxidant (such as an amine-based antioxidant), a vulcanizing agent (such as sulfur, a metal oxide, and a peroxide), and a functional filler (such as alumina).

### Surface Layer

In the first exemplary embodiment, the surface layer is a cured product of a composition containing a silsesquioxane compound. In the first exemplary embodiment, for example, the composition preferably further contains a rubber in addition to the silsesquioxane compound.

In the second exemplary embodiment, the surface layer is a cured product of a composition containing a silsesquioxane compound and a rubber.

### Silsesquioxane Compound

The silsesquioxane compound is a general term for a compound having a constitutional unit 3 represented by Formula (R¹SiO_{3/2})ₙ. In the formula, R¹ represents an organic group, and n represents a positive number of 2 or more. A plurality of R¹'s present in the constitutional unit 3 may be the same organic group or different organic groups. The silsesquioxane compound may be used alone or in combination of two or more kinds thereof.

In the constitutional unit 3, examples of the organic group represented by R¹ include a polymerizable functional group, a hydroxyl group, a siloxy group, a hydrocarbon group, a hydrocarbon group in which one or a plurality of methylene groups are replaced with a carbonyl group, a hydrocarbon group in which one or a plurality of carbon atoms are replaced with a heteroatom (an oxygen atom, a nitrogen atom, or a sulfur atom), and a group obtained by combining these groups.

Examples of the siloxy group include a monoalkylsiloxy group, a dialkylsiloxy group, and a trialkylsiloxy group. Among the above, the siloxy group is, for example, preferably a dialkylsiloxy group or a trialkylsiloxy group, and more preferably a trialkylsiloxy group.

Examples of the hydrocarbon group include an aliphatic hydrocarbon group and an aromatic hydrocarbon group.

Among the above, the aliphatic hydrocarbon group is, for example, preferably a hydrocarbon group having 1 or more and 20 or less carbon atoms, and more preferably a hydrocarbon group having 1 or more and 15 or less carbon atoms. The aliphatic hydrocarbon group may be linear, branched, or alicyclic. The aliphatic hydrocarbon group may be substituted with a substituent such as a halogen atom, a hydroxyl group, an amino group, and an aryl group.

Examples of the aromatic hydrocarbon group include a phenyl group, a naphthyl group, and an anthracenyl group. Among the above, the aromatic hydrocarbon group is, for example, preferably an aromatic hydrocarbon group having 6 or more and 18 or less carbon atoms, and more preferably an aromatic hydrocarbon group having 6 or more and 14 or less carbon atoms. The aromatic hydrocarbon group may be substituted with a substituent such as a halogen atom, a hydroxyl group, an amino group, an alkyl group, and an alkoxy group.

Examples of the polymerizable functional group include the same aspect as a polymerizable functional group represented by R¹ in the compound represented by Formula 1, that will be described later.

A three-dimensional structure of the silsesquioxane compound may be any of a cage type, a ladder type, or a random structure. The cage-type silsesquioxane compound is a concept including both “incomplete cage type” in which a part of the silsesquioxane skeleton has a cage structure and “complete cage type” in which the entire silsesquioxane skeleton has a cage structure.

### Compound Represented by Formula 1

The compound represented by Formula 1 is one of silsesquioxane compounds having various skeletal structures, in which a main chain skeleton consists of Si—O bonds. The compound represented by Formula 1 may be only one kind or two or more kinds.

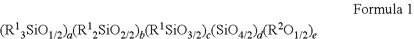

In Formula 1, R¹ represents a hydrogen atom, an alkyl group, an alkenyl group, an alkynyl group, an aralkyl group, an aryl group, a group represented by —C(—O)—CR³₃, or a monovalent organic group having a reactive group.

A plurality of R¹'s may be the same or different from each other.
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,

The monovalent organic group may be substituted with a halogen atom, a hydroxy group, an alkoxy group, an aryloxy group, an aralkyloxy group, or an oxy group. The alkyl group, the alkenyl group, the alkynyl group, the aralkyl group, and the aryl group may have a substituent.

a, b, d, and e each independently represent 0 or more and 1 or less, c represents more than 0 and 1 or less, and a+b+c+d+e=1. a, b, c, d, and e represent an average value of a proportion of the number of moles of each constitutional unit contained in one molecule of the compound.

The compound represented by Formula 1 has five constitutional units of “R¹₃SiO_{1/2}” (hereinafter, referred to as “constitutional unit 1”), “R¹₂SiO_{2/2}” (hereinafter, referred to as “constitutional unit 2”), “R¹SiO_{3/2}” (hereinafter, referred to as “constitutional unit 3”), “SiO_{4/2}” (hereinafter, referred to as “constitutional unit 4”), and “R₁O_{1/2}” (hereinafter, referred to as “constitutional unit 5”).

Each of the constitutional unit 1 to the constitutional unit 5 in Formula 1 may be only one kind or two or more kinds. In addition, an arrangement order of the constitutional units is not limited to the arrangement order represented by Formula 1, and is not particularly limited.

The compound represented by Formula 1 includes at least the constitutional unit 3 (that is, the constitutional unit represented by “R¹SiO_{3/2}”). That is, in Formula 1, c is a positive number of more than 0 and 1 or less.

For example, the compound represented by Formula 1 preferably includes the constitutional unit 2 together with the constitutional unit 3. That is, in Formula 1, for example, it is preferable that b and c are each independently a positive number of more than 0 and 1 or less, and a, d, and e are 0 or a positive number in a range of a+b+c+d+e=1.

The compound represented by Formula 1 may be composed of only the constitutional unit 3 (that is, c may be 1, and all of a, b, d, and e may be 0).

In Formula 1, R¹ is, for example, more preferably at least one selected from the group consisting of a polymerizable functional group, an aryl group, and an alkyl group, and still more preferably at least one selected from the group consisting of a (meth)acryloyl group, an oxetanyl group, an epoxy group, a methyl group, and a phenyl group.

A plurality of R¹'s in the constitutional units 1 to 3 in Formula 1 may be the same or different from each other.

### Constitutional Unit 1

The group represented by R¹ in the constitutional unit 1 (that is, the constitutional unit represented by “R¹₃SiO_{1/2}”) is at least one selected from the group consisting of a hydrogen atom, an alkyl group, an alkenyl group, an alkynyl group, an aralkyl group, an aryl group, —C(═O)—CR³₃, and a monovalent organic group having a reactive group (hereinafter, also referred to as a “polymerizable functional group”). For example, R¹ of the present constitutional unit preferably has at least one selected from the group consisting of a hydrogen atom, a polymerizable functional group, an aryl group, and an alkyl group; and more preferably has at least one selected from the group consisting of a polymerizable functional group, an aryl group, and an alkyl group. A plurality of R¹'s in the present constitutional unit may be the same or different from each other.

R¹ of the present constitutional unit may be a hydrogen atom. In a case where R¹ is a hydrogen atom, for example, in a case where at least one of the present constitutional unit or another constitutional unit includes an organic group having 2 or more and 10 or less carbon atoms, that includes a carbon-carbon unsaturated bond capable of being hydrosilylated and is included in the polymerizable functional group (hereinafter, also simply referred to as an unsaturated organic group), a crosslinking reaction may occur between these units.

R¹ of the present constitutional unit may be an alkyl group. The alkyl group may be an aliphatic group or an alicyclic group, and may be linear or branched. The number of carbon atoms in the alkyl group is, for example, preferably 1 or more and 10 or less, more preferably 1 or more and 4 or less, still more preferably 1 or more and 2 or less, and particularly preferably 1, that is, a methyl group. Specific examples of the alkyl group having 1 or more and 10 or less carbon atoms include a methyl group, an ethyl group, a propyl group, a butyl group, a pentyl group, a hexyl group, a heptyl group, an octyl group, a nonyl group, and a decyl group.

R¹ of the present constitutional unit may be an alkenyl group. The alkenyl group may be an aliphatic group, an alicyclic group, or an aromatic group, and may be linear or branched. The number of carbon atoms in the alkenyl group is, for example, preferably 1 or more and 10 or less. Specific examples of the alkenyl group having 1 or more and 10 or less carbon atoms include an ethenyl (vinyl) group, an ortho-styryl group, a meta-styryl group, a para-styryl group, a 1-propenyl group, a 2-propenyl (allyl) group, a 1-butenyl group, a 1-pentenyl group, a 3-methyl-1-butenyl group, a phenylethenyl group, an allyl(2-propenyl) group, and an octenyl (7-octen-1-yl) group.

R¹ of the present constitutional unit may be an alkynyl group. The alkynyl group may be an aliphatic group, an alicyclic group, or an aromatic group, and may be linear or branched. The number of carbon atoms in the alkynyl group is, for example, preferably 1 or more and 10 or less. Specific examples of the alkynyl group include an ethynyl group, a 1-propynyl group, a 1-butynyl group, a 1-pentynyl group, a 3-methyl-1-butynyl group, and a phenylbutynyl group.

R¹ of the present constitutional unit may be an aryl group. The number of carbon atoms in the aryl group is, for example, preferably 6 or more and 20 or less, more preferably 6 or more and 10 or less, and still more preferably 6, that is, a phenyl group. Examples of the aryl group having 6 or more and 20 or less carbon atoms include a phenyl group, a 1-naphthyl group, and a 2-naphthyl group.

R¹ of the present constitutional unit may be an aralkyl group. The number of carbon atoms in the aralkyl group is, for example, preferably 7 or more and 20 or less, and more preferably 7 or more and 10 or less. Examples of the aralkyl group having 7 or more and 20 or less carbon atoms include a phenylalkyl group such as a benzyl group.

R¹ of the present constitutional unit may be —C(—O)—CR³₃. R³ represents a hydrogen atom, a methyl group, or an ethyl group. R³ is, for example, preferably a methyl group. In a case of a plurality of R³'s, the plurality of R³'s may be the same or different from each other.

R¹ of the present constitutional unit may be a monovalent organic group having a reactive group (polymerizable functional group). Examples of the polymerizable functional group include a polymerizable functional group that can be thermoset or photocured. The polymerizable functional group is not particularly limited, and examples thereof include a vinyl group, an allyl group, a styryl group, a methacryloyl group, an acryloyl group, an acryloyloxy group, a methacryloyloxy group, an a-methylstyryl group, a vinyl ether group, a vinyl ester group, an acrylamide group, a methacrylamide group, an N-vinyl amide group, a maleic acid ester group, a fumaric acid ester group, an N-substituted maleimide group, an isocyanate group, an oxetanyl group, and an epoxy group. Among these, as the polymerizable functional group, for example, a polymerizable functional group having a (meth)acryloyl group, an oxetanyl group, or an epoxy group is preferable. The polymerizable functional group may be substituted with a halogen atom, a hydroxy group, an alkoxy group, an aryloxy group, an aralkyloxy group, or an oxy group.

As the polymerizable functional group having a (meth)acryloyl group, for example, a group represented by the following formula or a group including the group is preferable.

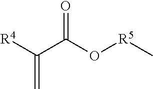

In the formula, R⁴ represents a hydrogen atom or a methyl group, and R⁵ represents an alkylene group having 1 or more and 10 or less carbon atoms. R⁴ is, for example, preferably an alkylene group having 2 or more and 10 or less carbon atoms.

The oxetanyl group is not particularly limited, and examples thereof include a (3-ethyl-3-oxetanyl) methoxy group and a (3-ethyl-3-oxetanyl)oxy group. As the polymerizable functional group having an oxetanyl group, for example, a group represented by the following formula or a group including the group is preferable.

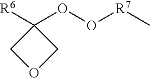

In the formula, R⁶ represents a hydrogen atom or an alkyl group having 1 or more and 6 or less carbon atoms, and R⁷ represents an alkylene group having 1 or more and 6 or less carbon atoms. R⁶ is, for example, preferably a hydrogen atom, a methyl group, an ethyl group, or the like, and more preferably an ethyl group. R⁷ is, for example, preferably an alkylene group having 2 or more and 6 or less carbon atoms, and more preferably a propylene group.

The polymerizable functional group having an epoxy group is not particularly limited, and examples thereof include an alkyl group having 1 or more and 10 or less carbon atoms, that is substituted with a glycidyloxy group, such as β-glycidyloxyethyl, γ-glycidyloxypropyl, and γ-glycidyloxybutyl; and an alkyl group having 5 or more and 10 or less carbon atoms, that is substituted with an oxirane group, such as a glycidyl group, a β-(3,4-epoxycyclohexyl)ethyl group, a γ-(3,4-epoxycyclohexyl)propyl group, a β-(3,4-epoxycycloheptyl)ethyl group, a 4-(3,4-epoxycyclohexyl)butyl group, and a 5-(3,4-epoxycyclohexyl)pentyl group.

The polymerizable functional group may be a functional group having a carbon-carbon double bond or a carbon-carbon triple bond, that can be hydrosilylated with a hydrogen atom (hydrosilyl group) bonded to a silicon atom. The unsaturated organic group can also function as the polymerizable functional group in a sense that the hydrogen atom in the hydrosilyl group polymerizes by a hydrosilylation reaction to form a hydrosilylated structural part. Specific examples of the unsaturated organic group include the above-described alkenyl group, alkynyl group, and the like. The unsaturated organic group is not particularly limited, and examples thereof include a vinyl group, an ortho-styryl group, a meta-styryl group, a para-styryl group, an acryloyl group, a methacryloyl group, an acryloxy group, a methacryloxy group, a 1-propenyl group, a 1-butenyl group, a 1-pentenyl group, a 3-methyl-1-butenyl group, a phenylethenyl group, an ethynyl group, a 1-propynyl group, a 1-butynyl group, a 1-pentynyl group, a 3-methyl-1-butynyl group, a phenylbutynyl group, an allyl(2-propenyl) group, and an octenyl (7-octen-1-yl) group. The unsaturated organic group is, for example, preferably a vinyl group, a para-styryl group, an allyl(2-propenyl) group, or an octenyl (7-octen-1-yl) group, and more preferably a vinyl group.

The compound represented by Formula 1 may include two or more kinds of the polymerizable functional groups in the entire molecule. In this case, all the polymerizable functional groups may be the same or different from each other. In addition, the plurality of polymerizable functional groups may be the same and may further include different polymerizable functional groups.

The alkyl group, the alkenyl group, the alkynyl group, the aralkyl group, the aryl group, —C(—O)—CR³₃, and the polymerizable functional group, represented by R¹, may have a substituent. Examples of the substituent include at least one or more of a halogen atom such as a fluorine atom, a chlorine atom, a bromine atom, and an iodine atom; an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group; a hydroxy group; an alkoxy group; an aryloxy group; an aralkyloxy group; an oxy group (═O); a cyano group; a protected hydroxyl group; and the like.

A protecting group of the hydroxyl group in the protected hydroxyl group is not particularly limited, and a known hydroxyl group-protecting group is used. For example, examples of the protecting group include an acyl-based protecting group represented by —C(═O)R (in the formula, R represents an alkyl group having 1 or more and 6 or less carbon atoms, such as a methyl group, an ethyl group, a n-propyl group, an isopropyl group, a n-butyl group, an isobutyl group, a s-butyl group, a tert-butyl group, and an n-pentyl group, or a phenyl group having or not having a substituent; examples of the substituent of the phenyl group having a substituent include an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group, a halogen atom such as a fluorine atom, a chlorine atom, and a bromine atom, an alkoxy group such as a methoxy group and an ethoxy group, and the like); a silyl-based protecting group such as a trimethylsilyl group, a triethylsilyl group, a tert-butyldimethylsilyl group, and a tert-butyldiphenylsilyl group; an acetal-based protecting group such as a methoxymethyl group, a methoxyethoxymethyl group, a 1-ethoxyethyl group, a tetrahydropyran-2-yl group, and a tetrahydrofuran-2-yl group; an alkoxycarbonyl-based protecting group such as a t-butoxycarbonyl group; and an ether-based protecting group such as a methyl group, an ethyl group, a tert-butyl group, an octyl group, an allyl group, a triphenylmethyl group, a benzyl group, a p-methoxybenzyl group, a fluorenyl group, a trityl group, and a benzhydryl group.

The compound represented by Formula 1 includes one kind or two or more kinds of the present constitutional units. In the compound represented by Formula 1, for example, it is preferable that at least a part of the present constitutional units has all of the three R¹'s being alkyl groups, and it is preferable that all of the present constitutional units have all of the three R¹'s being alkyl groups.

a, that is a proportion of the number of moles of the present constitutional unit in the compound represented by Formula 1, is a positive number of 0.00 or more and 1.00 or less. The lower limit value of a is not particularly limited, but is, for example, preferably 0.25 or more, more preferably 0.30 or more, and still more preferably 0.35 or more. The lower limit value of a may be 0.40 or more. The upper limit value of a is not particularly limited, but is, for example, preferably 0.50 or less, and more preferably 0.45 or less.

### Constitutional Unit 2

R¹ of the constitutional unit 2 (that is, the constitutional unit represented by “R¹₂SiO_{2/2}”) is at least one selected from the group consisting of a hydrogen atom, an alkyl group, an alkenyl group, an alkynyl group, an aryl group, an aralkyl group, —C(═O)—CR³₃, and a polymerizable functional group. R¹'s in the present constitutional unit may be the same or different from each other.

The various aspects described for the constitutional unit 1 can also be applied to the alkyl group, the alkenyl group, the alkynyl group, the aryl group, the aralkyl group, —C(═O)—CR³₃, and the polymerizable functional group of the present constitutional unit.

The compound represented by Formula 1 includes one kind or two or more kinds of the present constitutional units. In the compound represented by Formula 1, for example, it is preferable that at least a part of the present constitutional units has all of the two R¹'s being alkyl groups, and it is preferable that all of the present constitutional units have all of the two R¹'s being alkyl groups.

b, that is a proportion of the number of moles of the present constitutional unit in the compound represented by Formula 1, is a positive number of 0.00 or more and 1.00 or less. The lower limit value of b is not particularly limited, but is, for example, preferably 0.25 or more, more preferably 0.3 or more, and still more preferably 0.35 or more. The lower limit value of b may be 0.40 or more. The upper limit value of b is not particularly limited, but is, for example, preferably 0.50 or less, and more preferably 0.45 or less.

### Constitutional Unit 3

R¹ in the constitutional unit 3 (that is, the constitutional unit represented by “R¹SiO_{3/2}”) is at least one selected from the group consisting of a hydrogen atom, an alkyl group, an alkenyl group, an alkynyl group, an aralkyl group, an aryl group, —C(═O)—CR³₃, and a monovalent organic group having a reactive group (polymerizable functional group). R¹'s in the present constitutional unit may be the same or different from each other.

The various aspects described for the constitutional unit 1 can also be applied to the alkyl group, the alkenyl group, the alkynyl group, the aralkyl group, the aryl group, —C(═O)—CR³₃, and the polymerizable functional group of the present constitutional unit.

The compound represented by Formula 1 includes one kind or two or more kinds of the present constitutional units. For example, R¹ of one present constitutional unit may be an alkyl group, and R¹ of the other constitutional unit may be a polymerizable functional group. In addition, for example, R¹ of one present constitutional unit may be a hydrogen atom, and R¹ of the other constitutional unit may be an unsaturated organic group as the polymerizable functional group.

c, that is a proportion of the number of moles of the present constitutional unit in the compound represented by Formula 1, is a positive number of 0.00 or more and 1.00 or less. c is not particularly limited, but is, for example, preferably 0.25 or more and 1 or less, more preferably 0.30 or more and 1 or less, still more preferably 0.35 or more and 1 or less, and particularly preferably 0.40 or more and 1.00 or less. c may be 0.50 or more, 0.60 or more, 0.70 or more, 0.80 or more, 0.90 or more, 0.95 or more, 0.99 or more, or 1.

### Constitutional Unit 4

The constitutional unit 4 (that is, the constitutional unit represented by “SiO_{4/2}”) has a main chain of polysiloxane. A proportion of the present constitutional unit in the compound represented by Formula 1 is not particularly limited.

d, that is a proportion of the number of moles of the present constitutional unit in the compound represented by Formula 1, is a positive number of 0.00 or more and 1.00 or less. The lower limit value of d is not particularly limited, but is, for example, preferably 0.25 or more, more preferably 0.30 or more, and still more preferably 0.35 or more. The lower limit value of d may be 0.40 or more. The upper limit value of d is not particularly limited, but is, for example, preferably 0.90 or less.

### Constitutional Unit 5

The constitutional unit 5 (that is, the constitutional unit represented by “R²O_{1/2}”) defines a unit including an alkoxy group or a hydroxyl group in the compound represented by Formula 1. That is, R² in the present constitutional unit is a hydrogen atom or an alkyl group. The alkyl group may be an aliphatic group or an alicyclic group, and may be linear or branched. The number of carbon atoms in the alkyl group is, for example, preferably 1 or more and 10 or less. Specific examples of the alkyl group having 1 or more and 10 or less carbon atoms include a methyl group, an ethyl group, a n-propyl group, an isopropyl group, a butyl group, a pentyl group, and a hexyl group.

The alkoxy group in the present constitutional unit may be, for example, one that remains in the molecule in a synthesis process of the compound represented by Formula 1. In addition, the hydroxyl group in the present constitutional unit may be a hydroxyl group or the like, that remains in the molecule without polycondensation after hydrolysis of the “alkoxy group”.

e, that is a proportion of the number of moles of the present constitutional unit in the compound represented by Formula 1, is a positive number of 0.00 or more and 1.00 or less. The lower limit value of e is not particularly limited, but is, for example, preferably 0.20 or more, more preferably 0.25 or more, and still more preferably 0.30 or more. The lower limit value of e may be 0.40 or more. The upper limit value of e is not particularly limited, but is, for example, preferably 0.90 or less.

For example, the compound represented by Formula 1 preferably includes one or two or more selected from the group consisting of the constitutional unit 1, the constitutional unit 2, and the constitutional unit 4. That is, in Formula 1, for example, it is preferable that one or two or more of a, b, and d are positive numbers of 0 or more.

A content of the compound represented by Formula 1 in the entire silsesquioxane compound is, for example, preferably 80% by mass or more and 100% by mass or less, more preferably 90% by mass or more and 100% by mass or less, and still more preferably 95% by mass or more and 100% by mass or less.

The silsesquioxane compound may be in a particle shape or a non-particle shape such as a binding resin, but is, for example, preferably in a non-particle shape (hereinafter, also referred to as a non-particle silsesquioxane resin compound).

A content of the particle silsesquioxane compound (hereinafter, also referred to as silsesquioxane resin particles) with respect to the surface layer is, for example, preferably 0.0% by mass or less than 0.5% by mass, more preferably 0.0% by mass or 0.3% by mass or less, and still more preferably 0.0% by mass or 0.2% by mass or less.

In a case where the content of the silsesquioxane resin particles is less than 0.5% by mass, a variation in hardness and elasticity of the surface layer of the fixing member is suppressed. Therefore, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

In a case where the silsesquioxane compound is the non-particle silsesquioxane resin compound, a content of the silsesquioxane compound with respect to the surface layer is, for example, preferably 10% by mass or more and 90% by mass or less, more preferably 15% by mass or more and 85% by mass or less, and still more preferably 15% by mass or more and 70% by mass or less.

In a case where the content of the non-particle silsesquioxane resin compound is 10% by mass or more and 90% by mass or less, appropriate hardness and elasticity are imparted to the surface layer. Therefore, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

### Rubber

Examples of the rubber include polyurethane rubber such as ester-based polyurethane rubber and ether-based polyurethane rubber; silicone rubber such as polydimethylsiloxane rubber (a silicone rubber having a dimethyl organopolysiloxane structure as a main chain), methylvinyl silicone rubber, methylphenyl silicone rubber, and fluorosilicone rubber; fluororubber such as vinylidene fluoride-based rubber, tetrafluoroethylene/propylene-based rubber, tetrafluoroethylene/perfluoromethylvinyl ether rubber, phosphazene-based rubber, and fluoropolyether; chloroprene rubber; butadiene rubber; natural rubber; nitrile rubber; acrylic rubber; isoprene rubber; styrene rubber; ethylene-propylene-diene rubber; ethylene vinyl acetate rubber; chlorinated polyethylene rubber; epichlorohydrin rubber; polysulfide rubber; styrene butadiene rubber; acrylonitrile rubber; butyl rubber; and ethylene-propylene rubber.

Among the above, as the rubber, for example, it is preferable to contain at least one of a silicone rubber or a fluororubber, it is more preferable to contain a silicone rubber, and it is still more preferable to contain polydimethylsilicone rubber.

By forming the surface layer of the fixing member with the cured product of a composition containing the silsesquioxane compound and at least one of the silicone rubber or the fluororubber (for example, more preferably the silicone rubber and still more preferably the polydimethylsilicone rubber), the silsesquioxane compound and the rubber are mutually compatible or a fine sea-island structure is formed. As a result, the variation in toner release properties in the fixing unit is likely to be smaller. In addition, the slight variation in strength and elasticity as the surface layer of the fixing member also tends to decrease.

A content of the rubber with respect to the surface layer is, for example, preferably 10% by mass or more and 90% by mass or less, more preferably 20% by mass or more and 80% by mass or less, and still more preferably 30% by mass or more and 70% by mass or less.

In a case where the content of the rubber is 10% by mass or more, by the combination of the silsesquioxane compound and the rubber, appropriate hardness and elasticity are imparted to the surface layer. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

In a case where the content of the rubber is 90% by mass or less, excessive elasticity is not imparted to the surface layer, and thus the hardness is suppressed from decreasing. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

A mass ratio (silsesquioxane compound/rubber) of the content (% by mass) of the silsesquioxane compound to the content (% by mass) of the rubber in the surface layer is, for example, preferably 0.1 or more and 19.0 or less, more preferably 0.2 or more and 5.7 or less, and still more preferably 0.3 or more and 4.0 or less.

In a case where the mass ratio (silsesquioxane compound/rubber) is 0.1 or more, excessive elasticity is not imparted to the surface layer, and thus the hardness is suppressed from decreasing. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

In a case where the mass ratio (silsesquioxane compound/rubber) is 19.0 or less, the hardness of the surface layer is suppressed from being excessively high. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

The composition may further contain a material other than the silsesquioxane compound and the rubber. In a case where the composition is a mixture of other resins and the silsesquioxane compound, the other resins are, for example, preferably a so-called binding resin.

In a case where the composition is a mixture of other resins and the silsesquioxane compound, the silsesquioxane compound is, for example, preferably in a non-particle shape. Examples of the other resins contained in the composition include a polyimide resin (PI resin), a polyamide-imide resin (PAI resin), a polyether ketone resin (for example, an aromatic polyether ether ketone resin or the like), a polyphenylene sulfide resin (PPS resin), a polyetherimide resin (PEI resin), a polyester resin, a polystyrene resin, a polyamide resin, a polycarbonate resin, a silicone resin, and a mixed resin thereof.

A content of the fluororesin with respect to the surface layer is, for example, preferably 30% by mass or less, more preferably 20% by mass or less, and still more preferably 5% by mass or less. The above-described content of the fluororesin may be 0% by mass.

In a case where the above-described content of the fluororesin is 20% by mass or less, the value of the ratio (=B/A×100%) of the indentation depth B at a time of load release to the indentation depth A at a time of load application in the ultramicrohardness test (JIS Z 2255:2003) is easily adjusted to the above-described range. In addition, for example, it is preferable from the viewpoint of manufacturing with low environmental load.

### Ultramicrohardness

In the first exemplary embodiment, in the surface layer, the ratio (=B/A×100%) of the indentation depth B at a time of load release to the indentation depth A at a time of load application in the ultramicrohardness test (JIS Z 2255:2003) is 45% or less, and is, for example, preferably 40% or less, and more preferably 3% or more and 30% or less.

In the second exemplary embodiment, in the surface layer, the ratio (=B/A×100%) of the indentation depth B at a time of load release to the indentation depth A at a time of load application in the ultramicrohardness test (JIS Z 2255:2003) is, for example, preferably 45% or less, more preferably 40% or less, and still more preferably 3% or more and 30% or less.

In a case where the above-described ratio in the ultramicrohardness test is 45% or less, appropriate hardness and elasticity are imparted to the surface layer. As a result, plastic deformation of the surface layer is suppressed even in a case of the supply of the recording medium and in a case of stress concentration on the thickness of the recording medium or the corner of the cut edge. As a result, the scratches on the surface layer of the fixing member are reduced, and thus the release properties of the toner are excellent.

From the viewpoint of roughness-following property, the above-described ratio is, for example, preferably smaller, and the lower limit value thereof is not particularly limited.

From the viewpoint of suppressing a decrease in fixing properties and a decrease in glossiness due to a decrease in pressure for deforming and melting the toner, the above-described ratio is, for example, preferably 3% or more.

A method of setting the above-described ratio in the ultramicrohardness test to be in the above-described range is not particularly limited, and examples thereof include a method of forming the surface layer with a cured product of a composition containing a silsesquioxane compound and a rubber (for example, more preferably the compound represented by Formula 1 and the silicone rubber).

The measurement of the above-described ratio (=B/A×100%) is performed according to an ultramicrohardness test (JIS Z 2255:2003). In this case, since the characteristics of the surface layer with respect to the amount of deformation (for example, strain) of the surface layer due to paper thickness, paper edge portion, and the like are key, the range is set to be within a range of 3 μm to 10 μm in which the deformation amount of the indentation depth is constant. In addition, in a case of the evaluation, in order to remove the influence of a layer provided below the surface layer of the fixing member (that is, the base material layer and the elastic layer) as much as possible, the measurement is performed using a sample having a layer thickness of 10 times the indentation depth. Here, a value in a case where the indentation depth is 4 μm and the layer thickness of the evaluation sample is 40 μm is used.

### Surface Structure in Surface Layer

The surface layer may have a sea-island structure or may not have a sea-island structure.

A size of the sea-island structure can be controlled by, for example, a method of adjusting a solvent or the like in the coating liquid for forming a surface layer, a method of adjusting a mixing free energy (that is, a change in free energy in a process of mixing a plurality of pure substances to form a solution) by material selection, and the like.

The sea-island structure in the surface layer is, for example, preferably fine; and it is more preferable that an average interval between island portions is small, and it is still more preferable that the average interval between the island portions is less than 1 μm.

A method of confirming the sea-island structure and a method of measuring the “average interval between island portions” are as follows.

A section is produced from the surface layer of the fixing member, and the produced section is stained using osmium tetroxide or ruthenium tetroxide in a desiccator. The stained section is observed with a transmission electron microscope. Sea portions and island portions of the sea-island structure are distinguished by a difference in density due to a degree of staining of the resin with osmium tetroxide, and this is used for confirming the presence or absence of the sea-island structure. Using a Luzex image analysis device, the shortest distance from the outer peripheral edge of any one of 100 island portions (that is, an interface with the sea portions) to the outer peripheral edge of another island portion is obtained for each of the 100 island portions, and an arithmetic average value thereof is defined as the “average interval between island portions”.

In a case where the average interval between the sea portion and the island portion is small, the scratches are less likely to remain even in a local stress at a paper edge or a local stress in a region where a metal pigment or the like is carried (more specifically, for example, hysteresis loss is reduced).

In particular, in a case where the average interval between the sea portion and the island portion is less than 1 μm, occurrence of local offset of the toner is further suppressed, or occurrence of image defects due to a decrease in partial hysteresis loss is further reduced.

A thickness of the surface layer is, for example, preferably 5 μm or more and 200 μm or less, and more preferably 10 μm or more and 100 μm or less.

### Method of Forming Surface Layer

A method of forming the surface layer is not particularly limited, and a conventional method can be applied.

The surface layer may be formed on the base material by, for example, dipping a cylindrical mold in which the base material of the fixing belt is installed in a solution of a composition containing a silsesquioxane compound and a rubber precursor, and curing the coating film (for example, curing a resin component by irradiating with ultraviolet rays and vulcanizing the rubber by heating).

### Application of Fixing Member

The fixing member according to the present exemplary embodiment is applied to, for example, any of a heating belt or a pressurizing belt. The heating belt may be any of a heating belt heated by an electromagnetic induction method or a heating belt heated from an external heat source.

However, in a case where the fixing member according to the present exemplary embodiment is applied to the heating belt heated by an electromagnetic induction method, for example, a metal layer (heat generation layer) that generates heat by electromagnetic induction may be provided between the base material and the elastic layer.

### Heating Member

The heating member heats the fixing member.

The heating member is not particularly limited as long as it is a member that applies heat to the toner image transferred onto the surface of the recording medium by heating of the fixing member, and may be disposed on an inner peripheral surface side of the fixing member or may be disposed on an outer peripheral surface side of the fixing member.

As the heating member, a halogen lamp, a heating roll fixing device, an oven fixing device, an electromagnetic induction heating device, a resistive heating element, or the like is used.

As the heating roll fixing device, a heating roll type fixing device in which a pair of fixing rolls are opposed to each other and press-contacted is generally used. In the pair of fixing rolls, for example, a heating roll and a pressurizing roll are provided to face each other and are press-contacted to form a nip. The heating roll is formed by sequentially forming a metal hollow core having a heater lamp inside, a heat-resistant and oil-resistant elastic body layer (elastic layer), and a surface layer made of a fluororesin or the like; and the pressurizing roll is formed by sequentially forming a metal hollow core having a heater lamp inside, a heat-resistant and oil-resistant elastic body layer, and a surface layer as necessary. The recording medium on which the toner image is formed is passed through a nip region formed by the heating roll and the pressurizing roll to fix the toner image.

### Pressurizing Member

The pressurizing member is disposed to be in contact with the outer peripheral surface of the fixing member.

The pressurizing member may have, for example, a laminated structure in which a base material layer, an elastic layer, and a release layer are laminated in this order.

The pressurizing member may have, for example, a layer configuration in which a known metal layer for electromagnetic induction heating, a protective layer thereof, and an adhesive layer are interposed between the base material layer and the elastic layer may be adopted as necessary. In addition, a layer configuration in which an adhesive layer is interposed between the elastic layer and the surface layer may be adopted.

The pressurizing member according to the present exemplary embodiment may have a roll shape or a belt shape.

In a case where the pressurizing member has a roll shape, the pressurizing member may include, for example, a metal shaft portion that extends in a device depth direction and has a heating member such as a halogen lamp inside, a cylindrical elastic body layer through which the shaft portion penetrates, and a release layer that covers the elastic body layer.

The shaft portion is composed of, for example, a cylindrical metal body made of aluminum, stainless steel, or the like.

Preferred examples of the elastic layer include the same elastic layer as the elastic layer in the fixing member described above.

The release layer is composed of, for example, a fluororubber, a silicone rubber, a fluororesin, a silicone resin, or the like with a thickness of 20 μm or more and 50 μm or less. Obviously, the release layer is not limited to the materials, and materials that are known in the related art may be used.

In a case where the pressurizing member has a belt shape (hereinafter, referred to as a pressurizing belt), the pressurizing member is composed of, for example, at least a resin. The resin is a heat-resistant resin. The “heat-resistant” means a characteristic that melting or decomposition does not occur in a case of reaching a raised temperature of the fixing device (for example, a fixing temperature). The same applies hereinafter.

The pressurizing belt may be a single-layer resin base material layer; a laminate having a resin base material layer, an elastic layer provided on the resin base material layer, and a release layer provided on the elastic layer; or a laminate having a resin base material layer and a release layer provided on the resin base material layer. The resin base material layer may contain a conductive material in addition to the resin as necessary.

Preferred examples of the resin contained in the resin base material layer include the same resin as the base material layer in the fixing member.

Hereinafter, regarding the fixing device according to the present exemplary embodiment, a fixing device including a heating roll and a pressurizing belt will be described as a first exemplary embodiment; a fixing device including a heating belt and a pressurizing roll will be described as a second exemplary embodiment; and an electromagnetic induction heating-type fixing device including a heating belt and a heating roll will be described as a third exemplary embodiment.

The fixing device according to the present exemplary embodiment is not limited to the first to third exemplary embodiments, and may be a fixing device including a heating roll or a heating belt and a pressurizing belt.

### First Exemplary Embodiment of Fixing Device

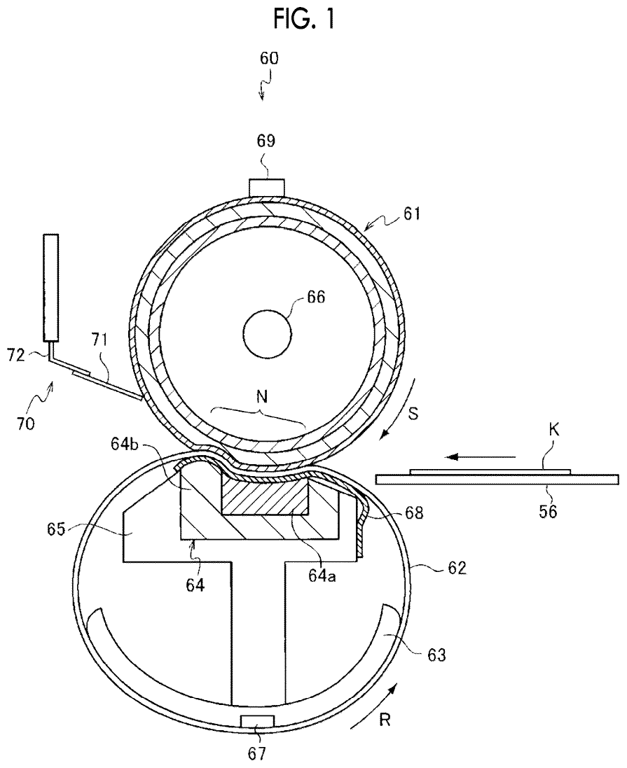

The first exemplary embodiment of the fixing device will be described with reference to FIG. 1. FIG. 1 is a schematic view showing an example (that is, a fixing device 60) of the fixing device according to the first exemplary embodiment.

As shown in FIG. 1, the fixing device 60 is configured, for example, with a heating roll 61 (an example of the first rotating body) that is driven to rotate, a pressurizing belt 62 (an example of the second rotating body), and a pressing pad 64 (an example of a pressing member) that presses the heating roll 61 through the pressurizing belt 62.

Regarding the pressing pad 64, for example, the pressurizing belt 62 and the heating roll 61 may be relatively pressed. Therefore, the pressurizing belt 62 may be pressed against the heating roll 61, or the heating roll 61 may be pressed against the pressurizing belt 62.

A halogen lamp 66 (an example of a heating device) is disposed inside the heating roll 61. The heating device is not limited to the halogen lamp, and other heating members that generate heat may be used.

Meanwhile, for example, a temperature-sensitive element 69 is disposed in contact with a surface of the heating roll 61. The lighting of the halogen lamp 66 is controlled based on a temperature measurement value by the temperature-sensitive element 69, and a surface temperature of the heating roll 61 is kept at a target set temperature (for example, 150° C.).

For example, the pressurizing belt 62 is rotatably supported by the pressing pad 64 and a belt traveling guide 63 that are disposed inside the pressurizing belt 62. In a sandwiching region N (nip portion), the pressurizing belt 62 is disposed to be pressed against the heating roll 61 by the pressing pad 64.

The pressing pad 64 is, for example, disposed in a state of being pressed against the heating roll 61 through the pressurizing belt 62 inside the pressurizing belt 62, and forms the sandwiching region N with the heating roll 61.

In the pressing pad 64, for example, a front sandwiching member 64a for securing a wide sandwiching region N is disposed on the inlet side of the sandwiching region N, and a peeling sandwiching member 64b for imparting distortion to the heating roll 61 is disposed on the outlet side of the sandwiching region N.

In order to reduce sliding resistance between an inner peripheral surface of the pressurizing belt 62 and the pressing pad 64, for example, a sheet-like sliding member 68 is provided on surfaces of the front sandwiching member 64a and the peeling sandwiching member 64b in contact with the pressurizing belt 62. The pressing pad 64 and the sliding member 68 are held by a metal holding member 65.

The sliding member 68 is provided, for example, such that a sliding surface thereof is in contact with the inner peripheral surface of the pressurizing belt 62, and is involved in holding and supplying an oil present between the sliding member 68 and the pressurizing belt 62.

For example, the belt traveling guide 63 is attached to the holding member 65, and the pressurizing belt 62 is configured to rotate.

The heating roll 61 rotates, for example, in a direction of an arrow S by a drive motor (not shown), and following the above rotation, the pressurizing belt 62 rotates in a direction of an arrow R, opposite to the rotation direction of the heating roll 61. That is, for example, the heating roll 61 rotates clockwise in FIG. 1, while the pressurizing belt 62 rotates counterclockwise.

Paper K (an example of a recording medium) having an unfixed toner image is guided by, for example, a fixing inlet guide 56, and transported to the sandwiching region N. While the paper K is passing through the sandwiching region N, the unfixed toner image on the paper K is fixed by the pressure and heat acting on the sandwiching region N.

In the fixing device 60, for example, by the front sandwiching member 64a in the form of a recess conforming to an outer peripheral surface of the heating roll 61, the wide sandwiching region Nis secured, compared to a configuration having no front sandwiching member 64a.

In addition, in the fixing device 60, for example, the peeling sandwiching member 64b is disposed to protrude from the outer peripheral surface of the heating roll 61 such that the distortion of the heating roll 61 is locally increased in an outlet region of the sandwiching region N.

In a case where the peeling sandwiching member 64b is disposed as described above, for example, the paper K after the fixing passes through a distortion position formed locally large in a case of passing through the peeling sandwiching region, and thus the paper K is easy to be peeled off from the heating roll 61.

As an auxiliary device for the peeling, for example, a peeling member 70 is disposed on the downstream side of the sandwiching region N of the heating roll 61. The peeling member 70 is, for example, held by a holding member 72 in a state in which a peeling claw 71 is close to the heating roll 61 in a direction facing the rotation direction of the heating roll 61 (counter direction).

### Second Exemplary Embodiment of Fixing Device

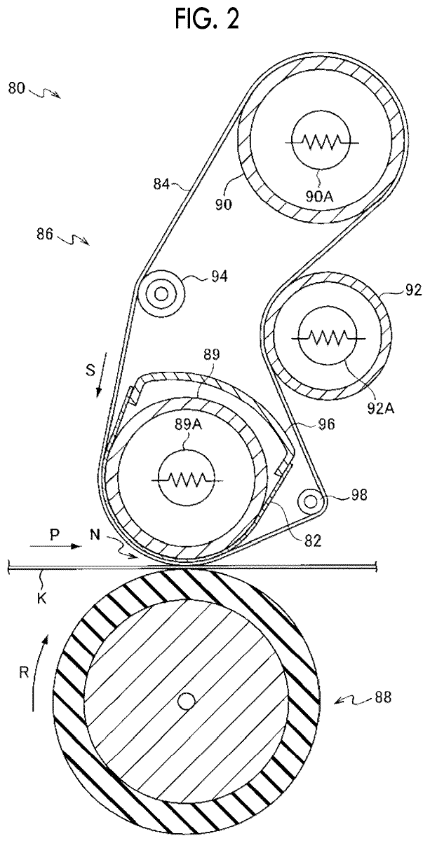

The second exemplary embodiment of the fixing device will be described with reference to FIG. 2. FIG. 2 is a schematic view showing an example (that is, a fixing device 80) of the fixing device according to the second exemplary embodiment.

As shown in FIG. 2, the fixing device 80 is configured, for example, with a fixing belt module 86 including a heating belt 84 (an example of the first rotating body) and a pressurizing roll 88 (an example of the second rotating body) arranged in a state of being pressed on a heating belt 84 (fixing belt module 86). For example, a sandwiching region N (nip portion) is formed in a contact portion between the heating belt 84 (the fixing belt module 86) and the pressurizing roll 88. In the sandwiching region N, paper K (an example of the recording medium) is pressed and heated, and the toner image is fixed.

The fixing belt module 86 includes, for example, an endless heating belt 84, a heating and pressing roll 89 around which the heating belt 84 is wound on the side of the pressurizing roll 88 and which is driven to rotate by the rotational force of a motor (not shown) and presses the heating belt 84 from an inner peripheral surface thereof toward the pressurizing roll 88, and a support roll 90 which supports the heating belt 84 from the inside at a position different from the heating and pressing roll 89.

The fixing belt module 86 is provided with, for example, a support roll 92 that is disposed outside the heating belt 84 and defines a circulating path thereof, a posture correction roll 94 that corrects the posture of the heating belt 84 from the heating and pressing roll 89 to the support roll 90, and a support roll 98 that applies a tension to the heating belt 84 from the inner peripheral surface on the downstream side of the sandwiching region N that is a region formed by the heating belt 84 and the pressurizing roll 88.

The fixing belt module 86 is provided, for example, such that a sheet-shaped sliding member 82 is interposed between the heating belt 84 and the heating and pressing roll 89. The sliding member 82 is provided, for example, such that a sliding surface thereof is in contact with the inner peripheral surface of the heating belt 84, and is involved in holding and supplying an oil present between the sliding member 82 and the heating belt 84. Here, the sliding member 82 is provided, for example, in a state in which both ends thereof are supported by a support member 96.

For example, a halogen heater 89A (an example of the heating device) is provided inside the heating and pressing roll 89.

The support roll 90 is, for example, a cylindrical roll made of aluminum, and a halogen heater 90A (an example of the heating device) is disposed therein, so that the heating belt 84 is heated from the inner peripheral surface side.

At both ends of the support roll 90, for example, spring members (not shown) pressing the heating belt 84 outward are disposed.

The support roll 92 is, for example, a cylindrical roll formed of aluminum, and a release layer consisting of a fluororesin having a thickness of 20 μm is formed on a surface of the support roll 92.

The release layer of the support roll 92 is formed, for example, for preventing a toner or paper dust from the outer peripheral surface of the heating belt 84 from accumulating on the support roll 92.

For example, a halogen heater 92A (an example of the heating device) is disposed inside the support roll 92 so that the heating belt 84 is heated from the outer peripheral surface side.

That is, for example, the heating and pressing roll 89, the support roll 90, and the support roll 92 are configured to heat the heating belt 84.

The posture correction roll 94 is, for example, a columnar roll made of aluminum, and an end position measurement mechanism (not shown) for measuring the end position of the heating belt 84 is disposed in the vicinity of the posture correction roll 94.

In the posture correction roll 94, for example, an axial direction displacement mechanism (not shown) that displaces a contact position of the heating belt 84 in an axial direction according to the measurement result of the end position measurement mechanism is disposed, and the posture correction roll 94 is configured to control meandering of the heating belt 84.

Meanwhile, the pressurizing roll 88 is, for example, rotatably supported, and the heating belt 84 is provided to be pressed against a portion wound around the heating and pressing roll 89 by an urging device such as a spring (not shown). As a result, as the heating belt 84 (heating and pressing roll 89) of the fixing belt module 86 moves rotationally in the direction of the arrow S, the pressurizing roll 88 follows the heating belt 84 (heating and pressing roll 89) and moves rotationally in the direction of the arrow R.

The paper K having an unfixed toner image (not shown) is transported in a direction of an arrow P and is guided to the sandwiching region N of the fixing device 80. While the paper K is passing through the sandwiching region N, the unfixed toner image on the paper K is fixed by the pressure and heat acting on the sandwiching region N.

For the fixing device 80, embodiments in which a halogen heater (halogen lamp) is used as an example of a plurality of heating devices is described; but the fixing device is not limited thereto, and a radiation lamp heating element (a heating element generating radiation (such as infrared rays)) and a resistance heating element (a heating element generating Joule heat by passing an electric current through a resistor; for example, a heating element obtained by forming a film with a resistor on a ceramic substrate and baking the resultant) other than the halogen heater may be used.

### Third Exemplary Embodiment of Fixing Device

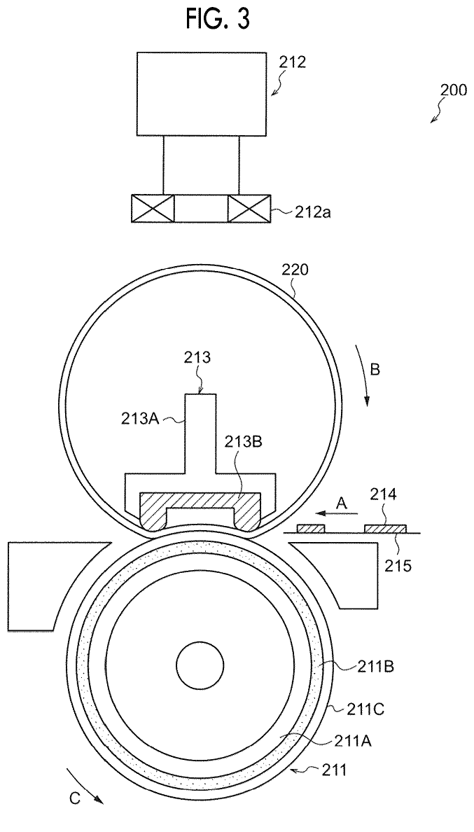

The third exemplary embodiment of the fixing device will be described with reference to FIG. 3. FIG. 3 is a schematic view showing an example (that is, a fixing device 200) of the fixing device according to the third exemplary embodiment.

As shown in FIG. 3, the fixing device 200 is an electromagnetic induction heating-type fixing device including a belt 220 having a metal layer.

In the fixing device 200, a pressurizing roll (pressurizing member) 211 is disposed such that pressure is applied to a part of the belt 220; and from the viewpoint of efficiently performing fixing, a contact region (nip) is formed between the belt 220 and the pressurizing roll 211, and the belt 220 is curved to conform to the peripheral surface of the pressurizing roll 211. In addition, from the viewpoint of ensuring peelability of the recording medium, a bent portion where the belt is bent is formed at the end of the contact region (nip).

The pressurizing roll 211 is configured with an elastic layer 211B made of silicone rubber or the like, that is formed on the base material 211A, and a release layer 211C formed of a fluorine-based compound, that is formed on the elastic layer 211B.

An opposing member 213 is disposed inside the belt 220 at a position facing the pressurizing roll 211. The opposing member 213 consists of a metal, a heat-resistant resin, heat-resistant rubber, or the like, and has a pad 213B that is in contact with the inner peripheral surface of the belt 220 to locally increase pressure, and a support 213A that supports the pad 213B.

An electromagnetic induction heating device 212 having a built-in electromagnetic induction coil (excitation coil) 212a is provided at a position facing the pressurizing roll 211 (an example of the pressurizing member) across the belt 220. The electromagnetic induction heating device 212 applies an alternating current to the electromagnetic induction coil such that the generated magnetic field changes by an excitation circuit and an eddy current is generated in a metal layer (not shown; for example, an electromagnetic induction metal layer) of the belt 220. The eddy current is converted into heat (Joule heat) by the electric resistance of the metal layer (not shown), and as a result, the surface of the belt 220 generates heat.

The position of the electromagnetic induction heating device 212 is not limited to the position shown in FIG. 3, and for example, the electromagnetic induction heating device 212 may be installed on the upstream side in a rotation direction B with respect to the contact region of the belt 220, or may be installed inside of the belt 220.

In the fixing device 200, by a driving device, a driving force is transmitted to the gear fixed to the end of the belt 220; and as a result, the belt 220 performs self-rotation in the direction of the arrow B, and as the belt 220 rotates, the pressurizing roll 211 rotates in the opposite direction, that is, in a direction of an arrow C.

A recording medium 215 on which an unfixed toner image 214 is formed is passed through a contact region (nip) between the belt 220 and the pressurizing roll 211 in the fixing device 200 in a direction of an arrow A, and pressure is applied to the molten unfixed toner image 214, so that the unfixed toner image 214 is fixed onto the recording medium 215.

### Image Forming Apparatus

Next, the image forming apparatus according to the present exemplary embodiment will be described.

The image forming apparatus according to the present exemplary embodiment includes:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
a fixing device that fixes the toner image on the surface of the recording medium.

In the image forming apparatus according to the present exemplary embodiment, the above-described fixing device according to the present exemplary embodiment is applied as the transfer device, or the above-described fixing device according to the present exemplary embodiment is applied as the fixing device. In addition, in the image forming apparatus according to the present exemplary embodiment, the above-described fixing device according to the present exemplary embodiment may be applied as the transfer device, and the above-described fixing device according to the present exemplary embodiment may be applied as the fixing device.

In the image forming apparatus according to the present exemplary embodiment, the transfer device and the fixing device may be made into each cartridge such that the transfer device and the fixing device are detachable from the image forming apparatus. That is, the image forming apparatus according to the present exemplary embodiment may include the fixing device according to the present exemplary embodiment and the transfer device according to the present exemplary embodiment, as a device configuring a process cartridge.

Hereinafter, the image forming apparatus according to the present exemplary embodiment will be described with reference to a drawing.

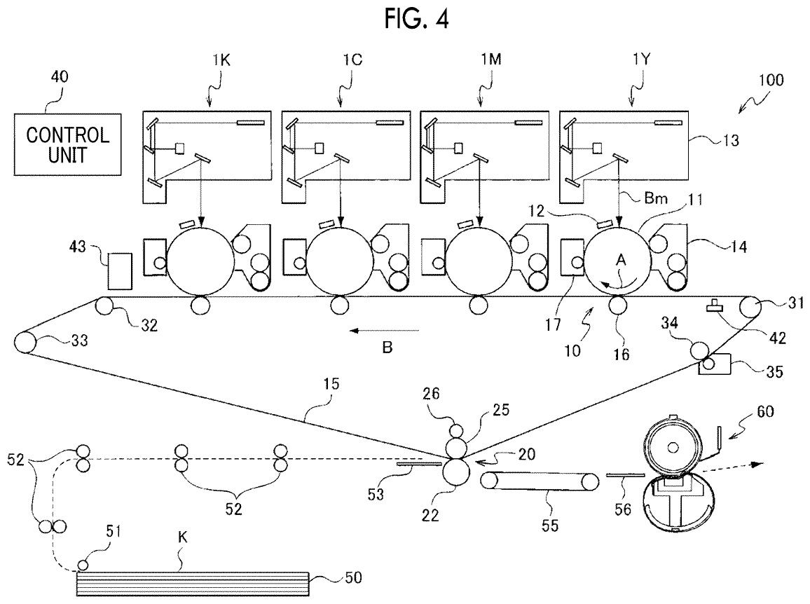

FIG. 4 is a schematic configuration view showing a configuration of the image forming apparatus according to the present exemplary embodiment.

As shown in FIG. 4, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer unit 10 that performs sequential transfer (primary transfer) of the toner image of each color component formed by each of the image forming units 1Y, 1M, 1C, and 1K to an intermediate transfer belt 15, a secondary transfer unit 20 that performs batch transfer (secondary transfer) of the overlapped toner images transferred to the intermediate transfer belt 15 to paper K as a recording medium, and a fixing device 60 that fixes the images transferred by the secondary transfer on the paper K. In addition, the image forming apparatus 100 includes a control unit 40 that controls the operation of each device (each unit).

Each of the image forming units 1Y, 1M, 1C, and 1K of the image forming apparatus 100 includes a photoreceptor 11 that rotates in a direction of an arrow A, as an example of an image holder that holds a toner image formed on the surface.

As an example of the charging device, a charger 12 for charging the photoreceptor 11 is provided around the photoreceptor 11, and as an example of the electrostatic latent image forming device, a laser exposure device 13 that draws an electrostatic latent image on the photoreceptor 11 is provided (in the figure, an exposure beam is represented by a reference numeral Bm).

Around the photoreceptor 11, as an example of the developing device, there are provided a developing machine 14 that accommodates toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer unit 10.

Furthermore, around the photoreceptor 11, there are provided a photoreceptor cleaner 17 that removes the residual toner on the photoreceptor 11 and devices for electrophotography, such as the charger 12, the laser exposure device 13, the developing machine 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 that is an intermediate transfer body is configured with a film-shaped pressurizing belt including a base layer that is a resin such as polyimide and polyamide, and containing an appropriate amount of an antistatic agent such as carbon black.

The intermediate transfer belt 15 is configured to have a volume resistivity of 10⁶ Ωcm or more and 10¹⁴ Ωcm or less, and has a thickness of, for example, approximately 0.1 mm. Specifically, the intermediate transfer belt 15 may be an intermediate transfer body constituted of the above-described member according to the present exemplary embodiment. In this case, the volume resistivity of the intermediate transfer belt 15 is set to be 10⁶ Ωcm or more and 10¹⁴ Ωcm or less, and the thickness thereof is, for example, preferably set to be approximately 0.1 mm.

By various rolls, the intermediate transfer belt 15 is driven to circulate (rotate) in the B direction shown in FIG. 4 at a speed fit for the purpose. The image forming apparatus 100 has, as the various rolls, a driving roll 31 that is driven by a motor (not shown) excellent in maintaining a constant speed and rotates the intermediate transfer belt 15, a support roll 32 that supports the intermediate transfer belt 15 substantially linearly extending along the arrangement direction of each photoreceptor 11, a tension applying roll 33 that applies tension to the intermediate transfer belt 15 and functions as a correcting roll preventing meandering of the intermediate transfer belt 15, a back roll 25 that is provided in the secondary transfer unit 20, and a cleaning back roll 34 that is provided in a cleaning portion scrapping off the residual toner on the intermediate transfer belt 15.

The primary transfer unit 10 is configured with the primary transfer roll 16 that is disposed to face the photoreceptor 11 across the intermediate transfer belt 15. The primary transfer roll 16 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive agent such as carbon black, and has a volume resistivity of 10^{7.5} Ωcm or more and 10^{8.5} Ωcm or less.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

A surface of the back roll 25 is configured with a tube of blended rubber of EPDM and NBR in which carbon is dispersed, and the inside of the back roll 25 is configured with EPDM rubber. The back roll 25 is formed such that a surface resistivity thereof is 10⁷ Ω/□ or more and 10¹⁰Ω/□ or less, and a hardness of the back roll 25 is set to, for example, 70° (ASKER C: manufactured by KOBUNSHI KEIKI CO., LTD.; the same applies hereinafter). The back roll 25 is disposed on the back surface side of the intermediate transfer belt 15 to configure a counter electrode of the secondary transfer roll 22, and a power supply roll 26 made of a metal to which secondary transfer bias is stably applied is disposed to come into contact with the back roll 25.

The secondary transfer roll 22 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive agent such as carbon black, and has a volume resistivity of 10^{7.5} Ωcm or more and 10^{8.5} Ωcm or less.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

On the downstream side of the secondary transfer unit 20 of the intermediate transfer belt 15, an intermediate transfer belt cleaner 35 that removes the residual toner or paper powder on the intermediate transfer belt 15 remaining after the secondary transfer and cleans the surface of the intermediate transfer belt 15 is provided to be separable from the intermediate transfer belt 15.

The intermediate transfer belt 15, the primary transfer unit 10 (primary transfer roll 16), and the secondary transfer unit 20 (secondary transfer roll 22) correspond to an example of the transfer device.

On the other hand, on the upstream side of the yellow image forming unit 1Y, a reference sensor (home position sensor) 42 is disposed that generates a reference signal to be a reference for taking the image forming timing in each of the image forming units 1Y, 1M, 1C, and 1K. The reference sensor 42 recognizes a mark provided on the back side of the intermediate transfer belt 15 and generates a reference signal, and each of the image forming units 1Y, 1M, 1C, and 1K is configured such that these units start to form images according to the instruction from the control unit 40 based on the recognition of the reference signal.

In addition, an image density sensor 43 used to adjust image quality is provided on the downstream side of the black image forming unit 1K.

The image forming apparatus according to the present exemplary embodiment includes, as a transport device for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer unit 20, a transport belt 55 that transports the paper K transported after going through secondary transfer by the secondary transfer roll 22 to the fixing device 60, and a fixing inlet guide 56 that guides the paper K to the fixing device 60.

Next, basic image forming process of the image forming apparatus according to the present exemplary embodiment will be described.

In the image forming apparatus according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. Image data on which the image processing is performed are converted into coloring material gradation data of four colors, that is, Y, M, C, and K, and are output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors Y, M, C, and K.

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport device, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. Before reaching the secondary transfer unit 20, the paper K is temporarily stopped, and a positioning roll (not shown) rotates according to the movement timing of the intermediate transfer belt 15 holding the toner image, so that the position of the paper K is aligned with the position of the toner image.

In the secondary transfer unit 20, through the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in an output portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the cleaning back roll 34 and the intermediate transfer belt cleaner 35.

Although the present exemplary embodiment has been described, the present exemplary embodiment is not limited to the above-described exemplary embodiments, and various modifications, changes, and ameliorations can be added thereto.

### EXAMPLES

Examples will be described below, but the present invention is not limited to these examples. In the following description, unless otherwise specified, “parts” and “%” are based on mass.

### Production of Fixing Belt

### Production of Fixing Belts 1 to 4 and 13 to 17

A solution for forming a surface layer, containing a silsesquioxane compound with the type and amount shown in Table 1, 10% by mass of heptane, and 60% by mass of dimethyl organopolysiloxane (manufactured by Shin-Etsu Chemical Co., Ltd., X34-1053-A/B), is prepared. As an elastic layer, X34-2086-A/B manufactured by Shin-Etsu Chemical Co., Ltd. is formed on a polyimide base material layer having a diameter of 168 mm to have the JIS-A hardness and the average thickness shown in Table 1. Subsequently, the solution for forming a surface layer is applied onto the elastic layer as the surface layer such that the film thickness is 30 μm, and the surface layer is cured through a heating step to obtain a fixing belt.

### Production of Fixing Belt 5: Example of Fluororubber

A solution for forming a surface layer, containing a silsesquioxane compound with the type and amount shown in Table 1, 10% by mass of heptane, and peroxide vulcanization type G-952 (manufactured by Daikin Industries, Ltd.) with the amount shown in Table 1, is prepared.

As an elastic layer, X34-2086-A/B manufactured by Shin-Etsu Chemical Co., Ltd. is formed on a polyimide base material layer having a diameter of 168 mm to have the JIS-A hardness (in the table, referred to as a rubber hardness) and the average thickness shown in Table 1. Subsequently, the solution for forming a surface layer is applied onto the elastic layer as the surface layer such that the film thickness is 30 μm, and the surface layer is cured through a heating step to obtain a fixing belt.

### Production of Fixing Belt 6

A fixing belt 6 is obtained in the same manner as the fixing belt 1, except that, in the production of the fixing belt 1, the average thickness of the elastic layer is set to the specification shown in Table 1.

### Production of Fixing Belt 7

A fixing belt 7 is obtained in the same manner as the fixing belt 1, except that, in the production of the fixing belt 1, the JIS-A hardness (in the table, referred to as a rubber hardness) of the elastic layer is set to the specification shown in Table 1.

### Production of Fixing Belts 8 to 20

Each fixing belt is obtained in the same manner as the fixing belt 1, except that, in the production of the fixing belt 1, the type and the amount of the silsesquioxane compound and the type and the amount of the rubber are set to the specifications shown in Table 1.

In a case where a surface of the surface layer of each of the fixing belts 1 to 20 is observed by the above-described measurement method, it is confirmed that all the fixing belts have a sea-island structure. Specifically, in the surface layer of each of the fixing belts 3, 5 to 12, 15, and 17 to 19, the average interval between the island portions is in a range of more than 0.7 μm and less than 1 μm; and in the surface layer of each of the fixing belts 1, 2, 4, 13, 14, 16, and 20, the average interval between the island portions is 0.7 μm.

The amount of the silsesquioxane compound in each fixing belt of Examples is shown in Table 1.

The abbreviations shown in Table 1 are as follows.

### —Silsesquioxane Compound—

SQ1: silsesquioxane compound in which R is a methyl group in the constitutional unit 3 of “R¹SiO_{3/2}”ₙ (manufactured by KONISHI CHEMICAL IND CO., LTD., SR-13H)
SQ2: cage-type silsesquioxane compound having an oxetanyl group (manufactured by TOAGOSEI CO., LTD., OX-SQ SI-20)
SQ3: cage-type silsesquioxane compound having a methacryloyl group (manufactured by TOAGOSEI CO., LTD., TM-100)
SQ4: cage-type silsesquioxane compound having an oxetanyl group (manufactured by TOAGOSEI CO., LTD., TX-100)
SQ5: silsesquioxane compound having an acryloyl group (manufactured by TOAGOSEI CO., LTD., TA-100)
SQ6: silsesquioxane compound in which the group represented by R¹ in the constitutional units 1 to 3 in the compound represented by Formula 1 has a phenyl group
SQ7: ladder-type silsesquioxane compound having an oxetanyl group
SQ8: random-type silsesquioxane compound having an oxetanyl group

### Production of Fixing Belt C1 for Comparative Example

As an elastic layer, X34-2086-A/B manufactured by Shin-Etsu Chemical Co., Ltd. is formed on a polyimide base material layer having a diameter of 168 mm to have the JIS-A hardness and the average thickness shown in Table 1. Subsequently, as a fluororesin surface layer, a PFA tube having a thickness of 35 μm and an outer diameter of @166 mm is formed by extrusion molding of a tetrafluoroethylene-perfluoroalkyl vinyl ether resin (PFA resin, 451-HPJ) manufactured by DuPont-Mitsui Fluorochemicals Co., Ltd., the PFA tube is expanded under reduced pressure, the expanded PFA tube is coated on the elastic layer, and the coating tube is heated at a predetermined temperature and cooled to room temperature to form a surface layer, thereby obtaining a fixing belt C1 for a comparative example.

The silsesquioxane compounds of SQ1 to SQ8 correspond to the compound represented by Formula 1.

In Table 1, “Monolayer” in the item “Form” of the silsesquioxane compound indicates that the silsesquioxane compound is contained in a non-particle shape as a so-called binding resin.

In Table 1, “Indentation depth ratio B/A” refers to a value of the ratio (=B/A×100%) of the indentation depth B at a time of load release to the indentation depth A at a time of load application in an ultramicrohardness test (JIS Z 2255:2003) in the surface layer of the fixing member.

In Table 1, “Mass ratio (Si/rubber)” refers to a mass ratio of the silsesquioxane compound to the rubber in the surface layer of the fixing member.

In Table 1, “Average value of surface pressure in nip portion” refers to an average value of a surface pressure in a nip portion formed at a contact portion between the fixing belt and the pressurizing roll.

### Production of Fixing Device and Image Forming Apparatus: Examples 1 to 21 and Comparative Example 1

Each fixing belt is mounted on a fixing device of an image forming apparatus (Revoria Press PC1120) manufactured by Fujifilm Business Innovation Corp. The fixing device has the configuration shown in FIG. 2. In addition, the image forming apparatus has the configuration shown in FIG. 4. An average value of the surface pressure in the nip portion formed at the contact portion between the fixing belt and the pressurizing roll in each example is as shown in Table 1.

### Evaluation of Paper Insertion Scratch

Using the image forming apparatus of each example and J paper (manufactured by Fujifilm Business Innovation Corp.), initial image quality disturbance (offset and paper insertion scratch) is evaluated with a halftone image. The evaluation standard is as follows. After printing 100 sheets of thick paper A4 size with 200 gsm in a vertical feed, a solid image in which 50% of four-color toners are superimposed is printed in A3 size, and it is checked whether a gloss change or an image defect occurs at a paper edge running position of A4 size.
S: no image disturbance or gloss reduction is visually observed.
A: slight gloss reduction is visually observed.
B: gloss reduction is visually observed at one location, but is within an allowable range.
C: gloss reduction is visually observed at two or three locations, but is within an allowable range.
D: image disturbance is visually observed.

### Evaluation of Toner Release Properties

Toner release properties of each example are evaluated as follows using the image forming apparatus of each example. A black solid image is formed on a mirror coat platinum 256 gsm paper (manufactured by Fujifilm Business Innovation Corp.), and the image is evaluated by visual observation. The evaluation standard is as follows.
S: no offset defect is visually observed in the image.
A: very slight offset defect is visually observed in the image, but is within an allowable range.
B: slight offset defect is visually observed in the image, but is within an allowable range.
C: offset defect is visually observed in the image, but is within an allowable range.
D: significant offset defect is visually observed in the image.

### Evaluation of Paper Roughness-following Property

Using the image forming apparatus of each example, images in which each image density of 50% is superimposed with four-color toners on A4 paper are output at a paper feed speed of 177 mm/s, including roughness portions of the paper. Thereafter, the surface of the fixed image is rubbed with a nonwoven fabric wiper, and a fixing degree is evaluated according to the following standard. As the A4 paper, embossed paper (REZAKKU 66 manufactured by Tokai Special Paper Co., Ltd.) having a large surface roughness is used.
S: image is fixed to the paper roughness portion.
A: image is fixed to the paper roughness portion, but fixing failure is observed at one location when rubbed, but is within an allowable range.
B: image is fixed to the paper roughness portion, but fixing failure is observed at two locations when rubbed, but is within an allowable range.
C: image is fixed to the paper roughness portion, but fixing failure is observed at three or four locations when rubbed, but is within an allowable range.
D: image is not fixed to the paper roughness portion.

TABLE 1

| | | Surface layer | | | | | | |
|---|---|---|---|---|---|---|---|---|
| | | Indentation | Silsesquioxane compound | | | Rubber component | | Mass |
| | | depth ratio | | | Amount | | Amount | ratio |
| | Fixing | B/A | | | (% by | | (% by | (Si/ |
| | belt | (%) | Type | Form | mass) | Type | mass) | rubber) |
| Example 1 | 1 | 38% | SQ1 | Monolayer | 50 | Si rubber | 50 | 1.0 |
| Example 2 | 2 | 28% | SQ1 | Monolayer | 20 | Si rubber | 80 | 0.3 |
| Example 3 | 3 | 42% | SQ1 | Monolayer | 80 | Si rubber | 20 | 4.0 |
| Example 4 | 4 | 38% | SQ1 | Monolayer | 50 | Si rubber | 50 | 1.0 |
| Example 5 | 5 | 43% | SQ1 | Monolayer | 50 | Fluorine | 50 | 1.0 |
| | | | | | | rubber | | |
| Example 6 | 1 | 38% | SQ1 | Monolayer | 50 | Si rubber | 50 | 1.0 |
| Example 7 | 6 | 38% | SQ1 | Monolayer | 50 | Si rubber | 50 | 1.0 |
| Example 8 | 7 | 38% | SQ1 | Monolayer | 50 | Si rubber | 50 | 1.0 |
| Example 9 | 8 | 2% | SQ1 | Monolayer | 10 | Si rubber | 90 | 0.1 |
| Example 10 | 9 | 44% | SQ1 | Monolayer | 85 | Si rubber | 15 | 5.7 |
| Example 11 | 10 | 10% | SQ1 | Monolayer | 15 | Si rubber | 85 | 0.2 |
| Example 12 | 11 | 35% | SQ2 | Monolayer | 50 | Si rubber | 50 | 1.0 |
| Example 13 | 12 | 28% | SQ3 | Monolayer | 50 | Si rubber | 50 | 1.0 |
| Example 14 | 13 | 33% | SQ4 | Monolayer | 50 | Si rubber | 50 | 1.0 |
| Example 15 | 14 | 40% | SQ5 | Monolayer | 50 | Si rubber | 50 | 1.0 |
| Example 16 | 15 | 25% | SQ6 | Monolayer | 50 | Si rubber | 50 | 1.0 |
| Example 17 | 16 | 44% | SQ1 | Monolayer | 80 | Si rubber | 20 | 4.0 |
| Example 18 | 17 | 60% | SQ1 | Monolayer | 95 | Si rubber | 5 | 19.0 |
| Example 19 | 18 | 41% | SQ7 | Monolayer | 50 | Si rubber | 50 | 1.0 |
| Example 20 | 19 | 40% | SQ8 | Monolayer | 50 | Si rubber | 50 | 1.0 |
| Example 21 | 20 | 28% | SQ1 | Monolayer | 65 | Si rubber | 35 | 1.9 |
| Comparative | C1 | 48% | — | — | — | — | — | — |
| Example 1 | | | | | | | | |

| | | | Average value | Evaluation | | |
|---|---|---|---|---|---|---|
| | Elastic layer | | of surface | | | Paper |
| | Rubber | Average | pressure in | | Toner | roughness- |
| | hardness | thickness | nip portion | Insertion | release | following |
| | (°) | (μm) | (Mpa) | scratch | properties | property |
| Example 1 | 34 | 400 | 0.3 | S | S | S |
| Example 2 | 25 | 300 | 0.3 | S | A | S |
| Example 3 | 34 | 350 | 0.3 | A | A | A |
| Example 4 | 48 | 120 | 0.3 | S | A | B |
| Example 5 | 48 | 300 | 0.3 | C | C | C |
| Example 6 | 34 | 400 | 0.08 | C | C | C |
| Example 7 | 48 | 90 | 0.3 | B | A | B |
| Example 8 | 55 | 400 | 0.3 | B | A | B |
| Example 9 | 48 | 300 | 0.3 | A | C | C |
| Example 10 | 48 | 300 | 0.3 | C | B | B |
| Example 11 | 48 | 300 | 0.3 | A | B | S |
| Example 12 | 34 | 400 | 0.3 | A | A | A |
| Example 13 | 34 | 400 | 0.3 | S | A | A |
| Example 14 | 34 | 400 | 0.3 | S | A | A |
| Example 15 | 34 | 400 | 0.3 | B | A | A |
| Example 16 | 34 | 400 | 0.3 | S | A | A |
| Example 17 | 52 | 90 | 0.3 | A | A | C |
| Example 18 | 34 | 400 | 0.3 | C | A | A |
| Example 19 | 34 | 400 | 0.3 | A | A | A |
| Example 20 | 34 | 400 | 0.3 | A | A | A |
| Example 21 | 34 | 350 | 0.3 | S | A | S |
| Comparative | 34 | 400 | 0.3 | D | D | D |
| Example 1 | | | | | | |

From the above results, it is found that the fixing device of the present example reduces the scratches on the surface layer of the fixing member and has excellent release properties of the toner even in a case where the recording medium has large roughness, as compared with the fixing device of the comparative example. In addition, it is found that the paper-following property is also excellent.

The present exemplary embodiments include the following aspects.

(((1))) A fixing device comprising:
a fixing member including a base material layer, an elastic layer disposed on the base material layer, and a surface layer that is disposed on the elastic layer and is a cured product of a composition containing a silsesquioxane compound;
a heating member that is configured to heat the fixing member; and
a pressurizing member disposed to be in contact with an outer peripheral surface of the fixing member,
wherein, in the surface layer of the fixing member, a ratio of an indentation depth B at a time of load release to an indentation depth A at a time of load application (=B/A×100%) in an ultramicrohardness test (JIS Z 2255:2003) is 45% or less.

(((2))) A fixing device comprising:
a fixing member including a base material layer, an elastic layer disposed on the base material layer, and a surface layer that is disposed on the elastic layer and is a cured product of a composition containing a silsesquioxane compound and a rubber;
a heating member that is configured to heat the fixing member; and
a pressurizing member disposed to be in contact with an outer peripheral surface of the fixing member.

(((3))) The fixing device according to (((1))) or (((2))),
wherein the silsesquioxane compound includes a compound represented by Formula 1,

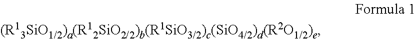

(in Formula 1,
R¹ represents a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).

(((4))) The fixing device according to (((3))),
wherein R¹ in Formula 1 is at least one selected from the group consisting of a (meth)acryloyl group, an oxetanyl group, an epoxy group, a methyl group, and a phenyl group.

(((5))) The fixing device according to (((2))),
wherein a mass ratio of a content of the silsesquioxane compound to a content of the rubber in the surface layer is 0.1 or more and 19.0 or less.

(((6))) The fixing device according to (((5))),
wherein the mass ratio is 0.3 or more and 4.0 or less.

(((7))) The fixing device according to (((5)
wherein the rubber includes at least one of a silicone rubber or a fluororubber.

(((8))) The fixing device according to any one of (((1))) to (((7))),
wherein an average thickness of the elastic layer is 100 μm or more.

(((9))) The fixing device according to any one of (((1))) to (((8))),
wherein a JIS-A hardness of the elastic layer is 50° or less.

(((10))) The fixing device according to any one of (((1))) to (((9))),
wherein an average value of a surface pressure in a nip portion formed at a contact portion between the fixing member and the pressurizing member is 0.2 MPa or more.

(((11))) The fixing device according to any one of (((1))) to ((10)
wherein, in the surface layer of the fixing member, the ratio of the indentation depth B at the time of load release to the indentation depth A at the time of load application (=B/A×100%) in the ultramicrohardness test (JIS Z 2255:2003) is 40% or less.

(((12))) The fixing device according to (((11))),
wherein, in the surface layer of the fixing member, the ratio of the indentation depth B at the time of load release to the indentation depth A at the time of load application (=B/A×100%) in the ultramicrohardness test (JIS Z 2255:2003) is 3% or more and 30% or less.

(((13))) An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to any one of (((1))) to (((12))), that fixes the toner image on the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing member including a base material layer, an elastic layer disposed on the base material layer, and a surface layer that is disposed on the elastic layer and is a cured product of a composition containing a silsesquioxane compound;
a heating member that is configured to heat the fixing member; and
a pressurizing member disposed to be in contact with an outer peripheral surface of the fixing member,
wherein, in the surface layer of the fixing member, a ratio of an indentation depth B at a time of load release to an indentation depth A at a time of load application (=B/A×100%) in an ultramicrohardness test (JIS Z 2255:2003) is 45% or less.

2. A fixing device comprising:
a fixing member including a base material layer, an elastic layer disposed on the base material layer, and a surface layer that is disposed on the elastic layer and is a cured product of a composition containing a silsesquioxane compound and a rubber;
a heating member that is configured to heat the fixing member; and
a pressurizing member disposed to be in contact with an outer peripheral surface of the fixing member.

3. The fixing device according to claim 1,
wherein the silsesquioxane compound includes a compound represented by Formula 1, 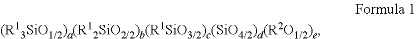
(in Formula 1,
R¹ represents a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).

4. The fixing device according to claim 2,
wherein the silsesquioxane compound includes a compound represented by Formula 1, 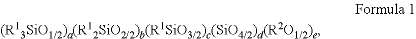
(in Formula 1,
R¹ represents a hydrogen atom, an alkyl group, an alkenyl group, an alkynyl group, an aralkyl group, an aryl group, a group represented by —C(═O)—CR³₃, or a monovalent organic group having a reactive group, provided that a plurality of R¹'s may be the same or different from each other,
R² represents a hydrogen atom or an alkyl group, provided that a plurality of R²'s may be the same or different from each other,
R³ represents a hydrogen atom, a methyl group, or an ethyl group, provided that a plurality of R³'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
a, b, d, and e each independently represent 0 or more and 1 or less, c represents more than 0 and 1 or less, and a+b+c+d+e=1).

5. The fixing device according to claim 3,
wherein R¹ in Formula 1 is at least one selected from the group consisting of a (meth)acryloyl group, an oxetanyl group, an epoxy group, a methyl group, and a phenyl group.

6. The fixing device according to claim 4,
wherein R¹ in Formula 1 is at least one selected from the group consisting of a (meth)acryloyl group, an oxetanyl group, an epoxy group, a methyl group, and a phenyl group.

7. The fixing device according to claim 1,
wherein a mass ratio of a content of the silsesquioxane compound to a content of the rubber in the surface layer is 0.1 or more and 19.0 or less.

8. The fixing device according to claim 7,
wherein the mass ratio is 0.3 or more and 4.0 or less.

9. The fixing device according to claim 7,
wherein the rubber includes at least one of a silicone rubber or a fluororubber.

10. The fixing device according to claim 1,
wherein an average thickness of the elastic layer is 100 μm or more.

11. The fixing device according to claim 2,
wherein an average thickness of the elastic layer is 100 μm or more.

12. The fixing device according to claim 7,
wherein an average thickness of the elastic layer is 100 μm or more.

13. The fixing device according to claim 8,
wherein an average thickness of the elastic layer is 100 μm or more.

14. The fixing device according to claim 9,
wherein an average thickness of the elastic layer is 100 μm or more.

15. The fixing device according to claim 1,
wherein a JIS-A hardness of the elastic layer is 50° or less.

16. The fixing device according to claim 2,
wherein a JIS-A hardness of the elastic layer is 50° or less.

17. The fixing device according to claim 1,
wherein an average value of a surface pressure in a nip portion formed at a contact portion between the fixing member and the pressurizing member is 0.2 MPa or more.

18. The fixing device according to claim 1,
wherein, in the surface layer of the fixing member, the ratio of the indentation depth B at the time of load release to the indentation depth A at the time of load application (=B/A×100%) in the ultramicrohardness test (JIS Z 2255:2003) is 40% or less.

19. The fixing device according to claim 18,
wherein, in the surface layer of the fixing member, the ratio of the indentation depth B at the time of load release to the indentation depth A at the time of load application (=B/A×100%) in the ultramicrohardness test (JIS Z 2255:2003) is 3% or more and 30% or less.

20. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 1, that fixes the toner image on the surface of the recording medium.
